(19) United States
(12) Patent Application Publication
(10) Pub. No.: US 2014/0051319 A1
(43) Pub. Date: Feb. 20, 2014

(54) PORTABLE PINATA POLE ASSEMBLY

(71) Applicant: Fred Scocozza, Chester, NY (US)

(72) Inventor: Fred Scocozza, Chester, NY (US)

(21) Appl. No.: 13/963,247

(22) Filed: Aug. 9, 2013

Related U.S. Application Data
(60) Provisional application No. 61/684,014, filed on Aug. 16, 2012.

(51) Int. Cl. F16M 11/00

(52) U.S. Cl. CPC F16M 11/00
USPC 446/5

(57) ABSTRACT

A portable piñata structure includes a weighted base and a vertical pole extending vertically from the weighted base. A horizontal pole is connected near the top of the vertical pole by a connector so that the horizontal pole can rotate about the axis of the vertical pole and can also pivoted up and down. A piñata is suspended directly from one end of the horizontal pole and the other end of the horizontal pole has a handle that may be grasped by an operator, The structure gives a wide range of fast movement to the piñata to make the game more interesting and also improves the safety of the operator.

### CROSS-REFERENCE TO RELATED APPLICATION

The present application claims the benefit of U.S. Patent Application Ser. No. 61/684,014, filed Aug. 16, 2012, which is hereby incorporated by reference in its entirety.

### BACKGROUND OF THE INVENTION

The present invention is a game product for parties or special occasions that is designed around the traditional piñata , but which can be safely hung and struck, is easily transportable and which allows for the rapid movement of the piñata over relatively large distances to improve game play.

A piñata is a container made often of papier-mâché, pottery, or cloth and decorated. It can be in the shape of an animal (e.g., a cow or ox) or a star. It is filled with toys and/or candy and is usually suspended by a rope from a stationary support, e.g., a tree or part of a building. A person, typically a child, is blind folded, and is given a stick with which they are supposed to strike the piñata and break it so that the toys or candy falls out.

In order to increase the play value, the person in addition to being blind folded, is often spun around so they become disoriented, making it more difficult to hit the piñata . Another means for improving the play value is to suspend the piñata by a rope pulley system. In that way the piñata can be raised or lowered to make it even more difficult for the blind folded player to strike it.

The piñata dates back to at least the 16^{th} century. In more recent years it has been proposed to suspend the piñata from a portable hoisting device as shown in U.S. Design Pat. D 542,501 of Lopez; U.S. utility Pat. No. 6,412,736 of Zaragoza, U.S. Pat. No. 6,669,152 of Hernandez, U.S. Pat. No. 6,978,974 of Marasco, and U.S. Published Application No. 2008/0073468 of Arroyo. In each of these devices the portable structure is equipped with the traditional rope pulley system.

U.S. Pat. No. 4,832,337 of Estrada and U.S. Pat. No. 6,685,146 of Sanchez disclose portable piñata stands without pulley systems, but they have horizontal arms that remain in a fixed plane so the piñata can move around, but not up and down.

### SUMMARY OF THE INVENTION

The present invention is directed to a portable piñata support structure that does not use a pulley system, but which allows the piñata to be moved easily up and down as well as around.

In an illustrative embodiment of the invention a weighted base has a pole extending vertically from it. At the top of the vertical pole there is a horizontal pole fastened so that it can rotate about the axis of the vertical pole and also pivoted up and down. The piñata is suspended directly from one end of the horizontal pole and the other end is grasped by the operator.

As the blind folded participant tries to strike the piñata , the operator is located at a safe distance from it on the opposite side of the vertical pole. Further, as the participant moves about, the operator and also position himself on the opposite side of the vertical pole, thus maintaining the safety of the operator.

Further, because of the rotatable and pivotable connection of the horizontal pole to the vertical one, the piñata can be moved in a great variety of directions in order to foil the attempts of the player to hit it. Because there is no rope pulley system involved, this movement can be very fast. Further, if the connection of the horizontal pole to the vertical pole is such that a greater proportion of the horizontal pole is toward the piñata , there is a mechanical advantage for the operator. For example, if one-third of the rod is toward the operator and two-thirds toward the piñata , the speed of movement and the distance of movement of the piñata is twice that of the movement of the operator's end of the pole.

### BRIEF DESCRIPTION OF THE DRAWINGS

The foregoing and other features of the present invention will be more readily apparent from the following detailed description and drawings of an illustrative embodiment of the invention in which:

FIG. 1 is a front elevation view of the base and vertical pole of the present invention with the rotary and pivotable fastener for the horizontal pole located at the top: and

FIG. 2 is a perspective view of the present invention with the horizontal pole and piñata assembled with the vertical pole and base.

### DESCRIPTION OF AN ILLUSTRATIVE EXEMPLARY EMBODIMENT

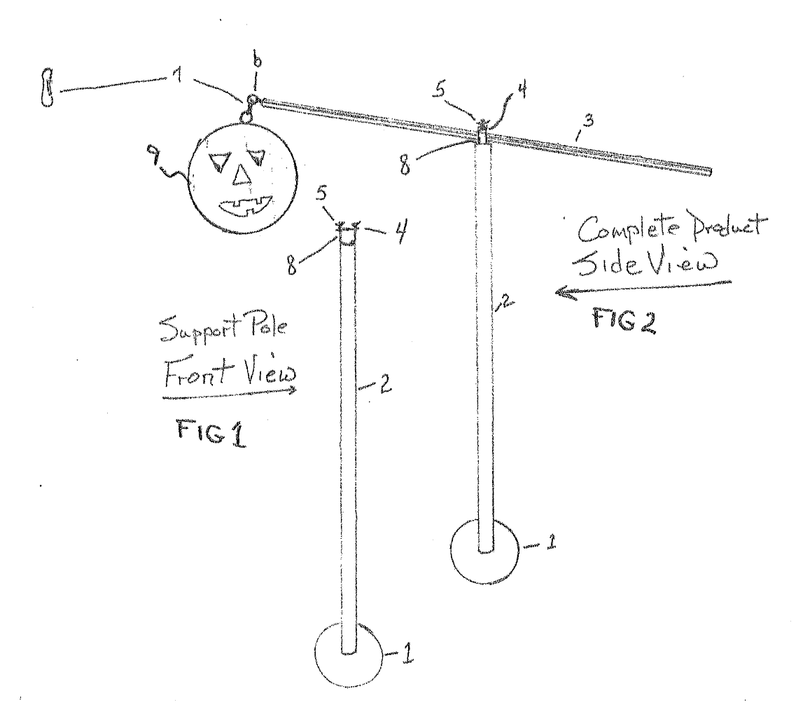

The piñata pole assembly of the present invention is a product for parties or special occasions. It is designed to allow a piñata to be safely hung and struck. As shown in FIG. 1, the invention includes a base 1 which supports a vertical pole 2. The base and vertical pole may be produced from plastic, wood, or metal and typically would measure approximately five feet high at the upper end of the vertical pole. Of course other heights could be used depending on the anticipated players.

The base is designed to be placed in any location and it would typically be weighted to prevent it from being tipped over easily. The connection between the base and vertical pole can be permanent. However, to increase the mobility of the invention the base may be detachably connected to the vertical pole, e.g., by mating screw threads on the pole and in a cylindrical channel that runs through the base (not shown).

At the top of the vertical pole there is a connector 4 which is rotatable in the upper end of the vertical pole. In addition, the connector has a fulcrum made from upwardly extending arms that support an axle between them. This axle is adapted to extend through a horizontal pole 3 to fasten it to the vertical pole 2 as shown in FIG. 2. Because of the rotary ability of the connector 4, the horizontal pole 3 can be rotated about vertical pole 3 by 360 degrees. Also, its pivotal connection on the axle of connector 4 means that it can be pivoted or rocked by up to 180 degrees about the axle so that it can move from a nearly completely downward direction to a nearly completely upward position by the operator moving his end of the pole.

A piñata 9 is shown in FIG. 2 connected to the end of pole 3 by an eye bolt 6. In this illustration the piñata looks like a decorated jack-o-lantern. The end of pole 3 opposite the piñata is the end grabbed and moved about by the operator. The horizontal pole 3 may measure approximately seven and one half feet long in a typical embodiment. However, other lengths of horizontal poles may be used as desired.

During play with the piñata , the blind folded participant tries to strike the piñata . This could create a safety issue if the operator is near the player. However, with the present invention the operator is located at a safe distance from the piñata on the opposite side of the vertical pole.

As the player moves about, the operator can maintain his position on the opposite side of the vertical pole, thus assuring his safety.

Because of the rotatable and pivotable (rocking) connection of the horizontal pole 3 to the vertical one 2, the piñata can be moved by the operator in a great variety of different directions in order to foil the attempts of the player to hit it. This movement can be very fast because the piñata is connected directly to pole 3 at one end and the operator moves the other end. Further, if the connection of the horizontal pole to the vertical pole is such that a greater proportion of the horizontal pole is toward the piñata , there is a mechanical advantage for the operator. For example, if one-third of the rod is toward the operator and two-thirds toward the piñata , the speed of movement and the distance of movement of the piñata is twice that of the movement of the operator's end of the pole.

Because there are not a large number of parts and no rope pulley system, the piñata pole assembly of the present invention can be put together, taken apart, and used easily in a matter of minutes with no tools. For example, the assembly can be broken down so that it can be easily transported by having the poles made in two or more parts that can be fastened together. The pole sections can be screwed together or one pole section can telescope within the other. By making the poles in smaller sections that can be fastened together, the unit in its disassembled state will be more compact and easier to transport. Transport is also enhanced because the assembly is light weight.

The appealing feature of the piñata pole is its convenience, practicality, safety, and ease of use. The piñata pole allows the user to hang a piñata in any desired location without having to suspend it from a stationary structure or tie off a rope pulley assembly. By suspending the piñata 9 from the horizontal extension pole 3, which is articulated to the vertical main support pole 2, the play value is increased over that of a piñata suspended from a stationary structure. In particular an operator can grasp the end of the horizontal pole 3 opposite from the piñata 9 and can move it so that the piñata at the other end moves. This makes it harder to hit and a more fun experience.

While the invention has been particularly shown and described with reference to preferred embodiments thereof, it will be understood by those skilled in the art that various changes in form and details may be made therein without departing from the spirit and scope of the invention.

I claim:

1. A portable piñata structure comprising:
a weighted base;
a vertical pole extending vertically from the weighted base;
a horizontal pole;
a connector located near the top of the vertical pole and fastening the horizontal pole to the vertical pole so that the horizontal pole can rotate about the axis of the vertical pole and can also pivoted up and down; and
a piñata suspended directly from one end of the horizontal pole and the other end of the horizontal pole having a handle that may be grasped by an operator.

2. The portable piñata structure of claim 1 wherein the connecter comprises:
a rotary joint that fits on top of the vertical pole and rotates with respect to the vertical pole, said rotary joint having two upwardly extending arms attached to and rotatable with the rotary joint, said upright members being on opposite sides of the vertical joint;
an axle extending between the upright members, said bar also extending through said horizontal pole; and
whereby said horizontal pole can rotate about the vertical pole by means of the rotary joint and can pivot up and down by means of the bar.
